(19) United States
(12) Patent Application Publication
(10) Pub. No.: US 2024/0026957 A1
(43) Pub. Date: Jan. 25, 2024

(54) CONJUGATE CAM REDUCER

(71) Applicant: National Sun Yat-Sen University, Kaohsiung City (TW)

(72) Inventors: Der-Min TSAY, Kaohsiung City (TW); Kun-Lung HSU, Kaohsuing City (TW); Wei-Ming CHEN, Kaohsuing City (TW); Jyun-Ting CHEN, Kaohsuing City (TW); Yuan-Shin LIN, Kaohsuing City (TW)

(73) Assignee: National Sun Yat-Sen University, Kaohsiung City (TW)

(21) Appl. No.: 18/065,515

(22) Filed: Dec. 13, 2022

(30) Foreign Application Priority Data
Jul. 25, 2022 (TW) 111127763

(51) Int. Cl. F16H 13/08

(52) U.S. Cl. CPC F16H 13/08

(57) ABSTRACT

A conjugate cam reducer includes input and output units disposed at two opposite sides of a transmission unit. The transmission unit includes smaller-diameter and larger-diameter cam discs axially connected with each other. The smaller-diameter and larger-diameter cam discs have first and second grooves. The input unit includes an input disc, an eccentric shaft and a plurality of input rollers. The input disc has a smaller inner peripheral wall engaging with the smaller-diameter cam disc, and a plurality of first receiving grooves registered with the first grooves to receive the input rollers. The eccentric shaft is rotated to drive rotation of the transmission unit in an eccentric cycloidal motion. The output unit includes an output disc having a larger inner peripheral wall which engages with the larger-diameter cam disc, and a plurality of second receiving grooves which are registered with the second grooves to receive a plurality of output rollers.

### CROSS-REFERENCE TO RELATED APPLICATION

This application claims priority to Taiwanese Invention Patent Application No. 111127763, filed on Jul. 25, 2022.

### FIELD

The disclosure relates to a speed reduction transmission device, and more particularly to a conjugate cam reducer.

### BACKGROUND

Referring to FIGS. 1 and 2, a conventional cycloid speed reducer 1 as disclosed in TW1738015 includes an input shaft 11, a cycloid disc 12 sleeved on the input shaft 11, a first roller assembly 13 surrounding the cycloid disc 12, and a second roller assembly 14 coupled with the cycloid disc 12. The input shaft 11 has an eccentric portion 112. The cycloid disc 12 includes an inner race portion 121 which defines an axial hole 120 for the eccentric portion 112 to be mounted therein, and an outer race portion 122 which is radially spaced apart from the inner race portion 121. The outer race portion 122 has an outer peripheral wall 123 formed with a plurality of outer grooves 128, and an inner peripheral wall 124 formed with a plurality of inner grooves 129. The curvature of each outer groove 128 is smaller than the curvature of each inner groove 129 such that the outer and inner grooves 128, 129 have different arc lengths.

The first roller assembly 13 includes a first disc 131 formed with a plurality of first grooves 130 in an inner peripheral wall thereof, and a plurality of first rollers 132 respectively received in the first grooves 130 and disposed in the outer grooves 128. The second roller assembly 14 includes a second disc 141 formed with a plurality of second grooves 140 in an outer peripheral wall thereof, and a plurality of second rollers 142 respectively received in the second grooves 140 and disposed in the inner grooves 129. The first and second rollers 132, 142 are in the same form. By the outer grooves 128 having a different sliding path from that of the inner grooves 129, and the eccentric portion 112 of the input shaft 11, the cycloid speed reducer performs speed reduction transmission.

However, such cycloid speed reducers have a complicated structure. The first and second discs 131, 141 must be formed with the first and second grooves 130, 140 in a precise manner for accurate mounting of the first and second rollers 132, 142 in the grooves. Moreover, the cycloid disc 12 has the inner grooves 129 and the outer grooves 128 formed in the inner and outer peripheral walls, which is complicated and inconvenient to machine and results in difficulty in miniaturizing the product.

### SUMMARY

Therefore, an object of the disclosure is to provide a conjugate cam reducer that can alleviate at least one of the drawbacks of the prior art.

According to the disclosure, the conjugate cam reducer includes a transmission unit defining an axial hole which extends along an output axis, and an input unit and an output unit which are connected with the transmission unit and respectively disposed at two opposite sides of the transmission unit along the output axis. The transmission unit includes a smaller-diameter cam disc and a larger-diameter cam disc which extends from a side of the smaller-diameter cam disc along the output axis and which has an outer diameter larger than that of the smaller-diameter cam disc. The smaller-diameter cam disc has a plurality of first teeth which are formed circumferentially and angularly spaced apart from one another, and a plurality of first grooves each of which is formed between two adjacent ones of the first teeth. The larger-diameter cam disc has a plurality of second teeth which are formed circumferentially and angularly spaced apart from one another, and a plurality of second grooves each of which is formed between two adjacent ones of the second teeth. The input unit includes an input disc, an eccentric shaft and a plurality of input rollers. The input disc has first and second input disc sides opposite to each other along the output axis. The input disc defines a disc hole which extends from the first input disc side to the second input disc side. The input disc further has a smaller inner peripheral wall which extends from the second input disc side along the output axis and which engages with the smaller-diameter cam disc, and a plurality of first receiving grooves which extend radially and outwardly from the smaller inner peripheral wall and which are formed circumferentially and angularly spaced apart from one another. The first receiving grooves are respectively registered with and spatially communicate with the first grooves to cooperatively define a plurality of receiving spaces. The eccentric shaft extends through the disc hole and the axial hole, and has an input shaft end which extends along an eccentric axis parallel to the output axis and which is rotated to drive rotation of the transmission unit in an eccentric cycloidal motion. The input rollers are rollably disposed in the receiving spaces, respectively. The output unit includes an output disc and a plurality of output rollers. The output disc has first and second output disc sides opposite to each other along the output axis and distal from and proximate to the input disc, respectively, a larger inner peripheral wall which extends from the second output disc side along the output axis toward the first output disc side and which engages with the larger-diameter cam disc, and a plurality of second receiving grooves which extend radially and outwardly from the larger inner peripheral wall and which are formed circumferentially and angularly spaced apart from one another. The second receiving grooves are respectively registered with and spatially communicate with the second grooves to cooperatively define a plurality of accommodation spaces. The output rollers are rollably disposed in the accommodation spaces, respectively.

Through the rotation of the transmission unit by the eccentric shaft, and with the input rollers and the output rollers disposed in a freely rollable manner, the output disc is rotated relative to the input disc at a reduced speed. The conjugate cam reducer has a simple component arrangement. The input disc and the output disc are made in a simple manufacturing process without the need for highly difficult finishing processes to be performed so as to facilitate miniaturization. With the freely rollable arrangement of the input rollers and the output rollers, the input rollers and the output rollers are available and easily assembled so as to further facilitate the reduction of the reducer's size.

### BRIEF DESCRIPTION OF THE DRAWINGS

Other features and advantages of the disclosure will become apparent in the following detailed description of the embodiments with reference to the accompanying drawings. It is noted that various features may not be drawn to scale.

FIG. 1 is an exploded perspective view of a conventional cycloid speed reducer disclosed in TW1738015.

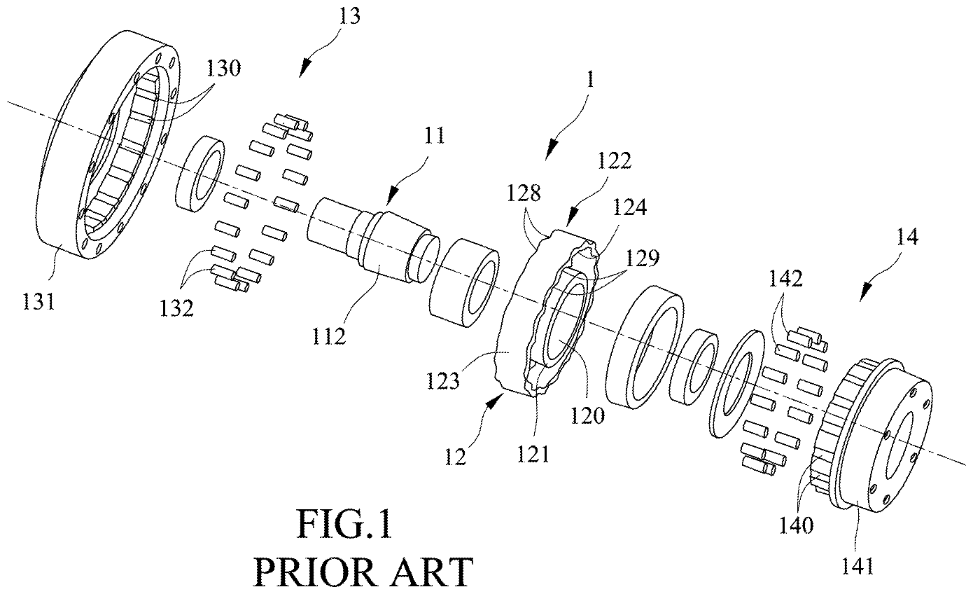

FIG. 2 is a schematic side view of the conventional cycloid speed reducer.

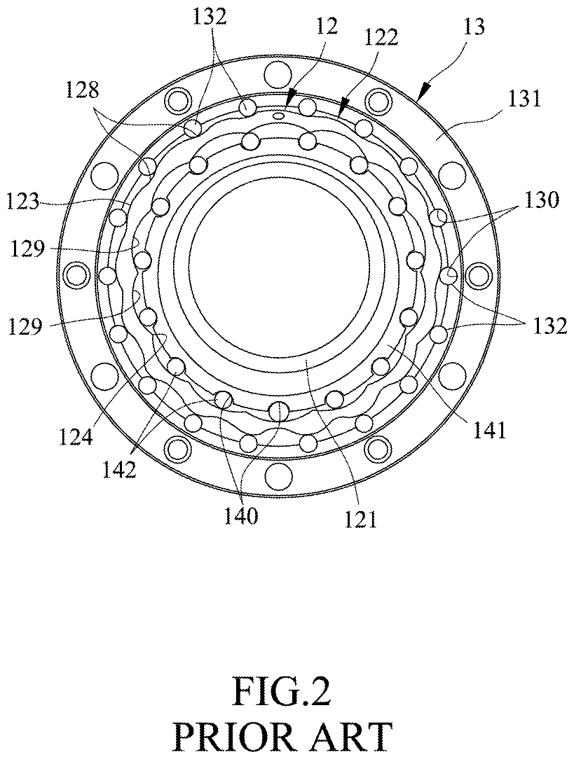

FIG. 3 is an exploded perspective view illustrating an embodiment of a conjugate cam reducer according to the disclosure.

FIG. 4 is a schematic side view of an input unit and an output unit of the embodiment.

FIG. 5 is a sectional view of the embodiment.

FIG. 6 is a perspective view illustrating an output unit of a modified embodiment.

FIG. 7 is a perspective view illustrating an output unit of another modified embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

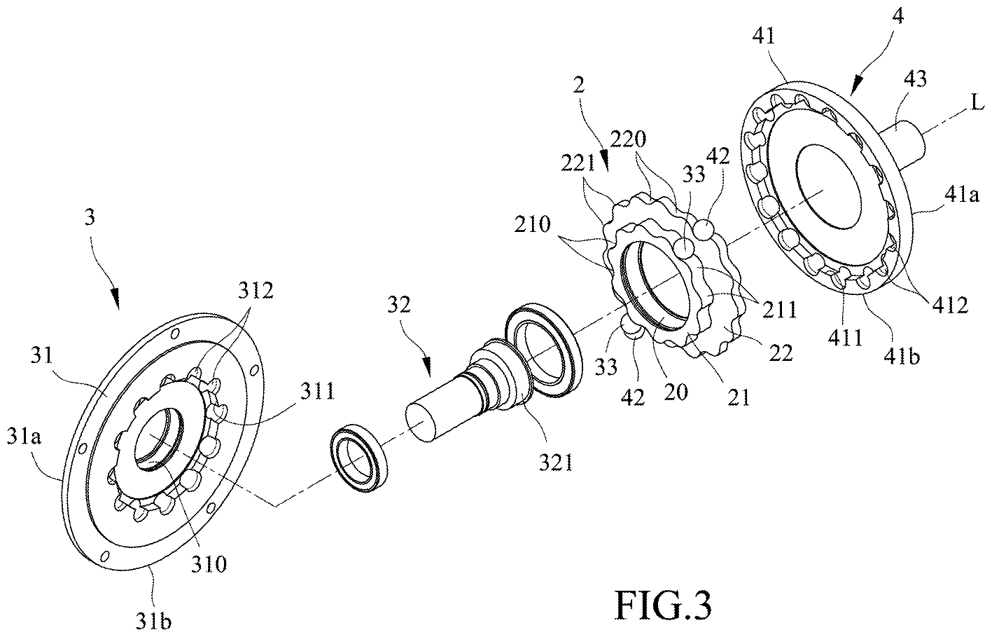

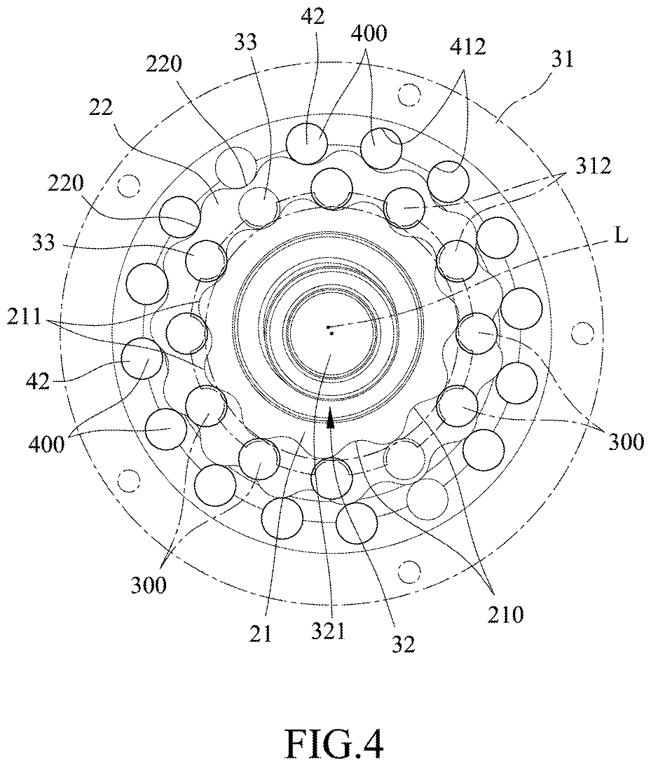

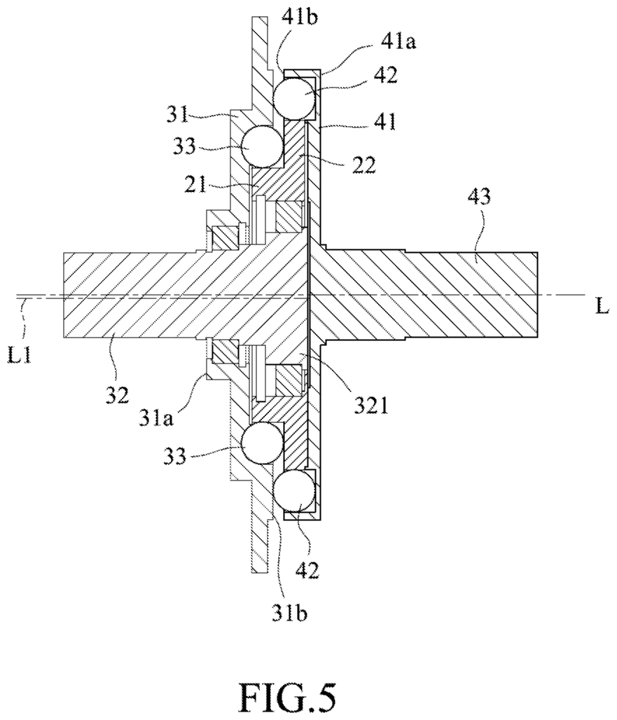

Referring to FIGS. 3 to 5, an embodiment of a conjugate cam reducer according to the disclosure includes a transmission unit 2 which defines an axial hole 20 that extends along an output axis (L), and an input unit 3 and an output unit 4 which are connected with the transmission unit 2 and respectively disposed at two opposite sides of the transmission unit 2 along the output axis (L). The input unit 3 is coupled with and driven by a power, such as a motor. The drive from the input unit 3 is transmitted through the transmission unit 2 to the output unit 4 at a reduced speed.

The transmission unit 2 includes a smaller-diameter cam disc 21 and a larger-diameter cam disc 22 which is securely connected with and extends from a side of the smaller-diameter cam disc 21 along the output axis (L), and which has an outer diameter larger than that of the smaller-diameter cam disc 21. Specifically, the smaller-diameter cam disc 21 is integrally and coaxially formed with the larger-diameter cam disc 22 so as to form the transmission unit 2 as a conjugated cam piece with smaller-diameter and larger-diameter segments. The smaller-diameter cam disc 21 has a plurality of first teeth 211 which are formed circumferentially and angularly spaced apart from one another in an equidistant manner, and a plurality of first grooves 210 each of which is formed between two adjacent ones of the first teeth 211. The larger-diameter cam disc 22 has a plurality of second teeth 221 which are formed circumferentially and angularly spaced apart from one another in an equidistant manner, and a plurality of second grooves 220 each of which is formed between two adjacent ones of the second teeth 221. It is noted that the first teeth 211 may have the same interval as the second teeth 221. Hence, in accordance with the diameters of the smaller-diameter cam disc 21 and the larger-diameter cam disc 22, a predetermined number of the first grooves 210 and a predetermined number of the second grooves 220 may be respectively formed in the outer peripheral walls of the smaller-diameter cam disc 21 and the larger-diameter cam disc 22 so as to simplify the manufacturing process of the transmission unit 2.

The input unit 3 includes an input disc 31, an eccentric shaft 32 and a plurality of input rollers 33. The input disc 31 is adapted to be connected with a housing (not shown) to cooperatively define an accommodation chamber for accommodating the transmission unit 2. The input disc 31 has first and second input disc sides (31a, 31b) opposite to each other along the output axis (L). The input disc 31 defines a disc hole 310 which extends from the first input disc side (31a) to the second input disc side (31b). The input disc 31 has a smaller inner peripheral wall 311 which extends from the second input disc side (31b) along the output axis (L) and which engages with the smaller-diameter cam disc 21, and a plurality of first receiving grooves 312 which extend radially and outwardly from the smaller inner peripheral wall 311 and which are formed circumferentially and angularly spaced apart from one another in an equidistant manner about the output axis (L). The eccentric shaft 32 extends through the disc hole 310 and the axial hole 20, and has an input shaft end 321 which extends along an eccentric axis (L1) parallel to and offset from the output axis (L) and which is rotated to drive rotation of the transmission unit 2 in an eccentric cycloidal motion. The first receiving grooves 312 are respectively registered with and spatially communicate with the first grooves 210 to cooperatively define a plurality of receiving spaces 300 which are formed circumferentially and angularly spaced apart from one another in an equidistant manner about the output axis (L). Each of the first receiving grooves 312 has a cross-section which is of one of a trapezoidal, a circular and a Gothic arch shape. Each input roller 33 may be in the form of a metal spherical ball which are widely available. The input rollers are freely and rollably disposed in the receiving spaces 300, respectively. Thus, no retaining structure is needed to accommodate and confine the input rollers 33 within certain configurations, thereby simplifying the manufacturing process.

The output unit 4 includes an output disc 41, a plurality of output rollers 42 and an output shaft 43. The output disc 41 has first and second output disc sides (41a, 41b) opposite to each other along the output axis (L) and distal from and proximate to the input disc 31, respectively, a larger inner peripheral wall 411 which extends from the second output disc side (41b) along the output axis (L) toward the first output disc side (41a) and which engages with the larger-diameter cam disc 22, and a plurality of second receiving grooves 412 which extend radially and outwardly from the larger inner peripheral wall 411 and which are formed circumferentially and angularly spaced apart from one another in an equidistant manner about the output axis (L). The second receiving grooves 412 are respectively registered with and spatially communicate with the second grooves 220 to cooperatively define a plurality of accommodation spaces 400 which are formed circumferentially and angularly spaced apart from one another in an equidistant manner about the output axis (L). Each second receiving groove 412 has a cross-section which is of one of trapezoidal, circular and Gothic arch shapes. Each output roller 42 may be in the form of a metal spherical ball which are easily available. The output rollers 42 are freely and rollably disposed in the accommodation spaces 400, respectively. Thus, no retaining structure is needed to accommodate and confine the output rollers 42 within certain configurations, thereby simplifying the manufacturing process. The output shaft 43 extends from the first output disc side (41a) of the output disc 41 along the output axis (L) and away from the transmission unit 2.

In this embodiment, the input unit 3 and the output unit 4 are disposed at two opposite sides of the transmission unit 2 to have the smaller-diameter cam disc 21 of the transmission unit 2 radially facing the smaller inner peripheral wall 311 of the input disc 3, and the larger-diameter cam disc 22 of the transmission unit 2 radially facing the larger inner peripheral wall 411 of the output disc 41. Rotation of the eccentric shaft 32 results in rotation of both the smaller-diameter cam disc 21 and the larger-diameter cam disc 22 of the transmission unit 2. During the rotation of the transmission unit 2 about the output axis (L), each of the input rollers 33 and each of the outer rollers 42 are freely rollable to serve as a contact medium disposed between the input disc 31 and the smaller-diameter cam disc 21, and between the larger-diameter cam disc 22 and the output disc 41. With the smaller-diameter cam disc 21 having a diameter different from that of the larger-diameter cam disc 22, the rotational energy of the eccentric shaft 32 is transmitted to the output shaft 43, causing the output shaft 43 to rotate at a predetermined reduced speed.

In this embodiment, aside from the input rollers 33 and the output rollers 42, the reducer only includes four component parts which are the input disc 31, the eccentric shaft 32, the transmission unit 2 and the output disc 41, and has a simple component arrangement. Moreover, the input disc 31 is formed with the first receiving grooves 312 and the output disc 41 is formed with the second receiving grooves 412, which can be machined in a simple manufacturing process without the need for highly difficult finishing processes to be performed, and may facilitate the miniaturization of the reducer. Thus, with the freely rollable arrangement of the input rollers 33 and the output rollers 42, the input rollers 33 and the output rollers 42 are available and easily assembled so as to further facilitate reducing the size of the reducer.

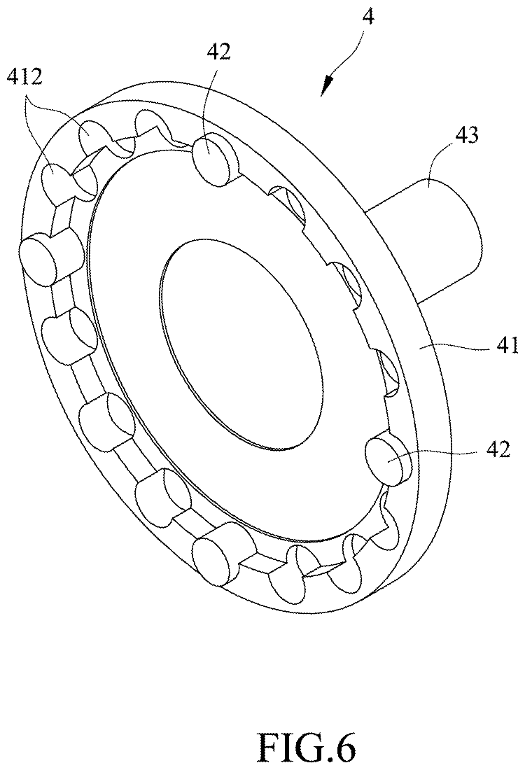

As shown in FIG. 6, in a modified embodiment, each of the input rollers 33 and each of the output rollers 42 are in the form of cylindrical rollers each of which extends in a direction parallel to the output axis (L). FIG. 6 illustrates only the output rollers 42 and the output disc 41, while the input rollers 33 and the input disc 31 may be inferred from the previously disclosed examples. In comparison with the spherical balls, the cylindrical rollers have an increased contact area with the corresponding disc 31, 41 so as to stabilize the connection among the input disc 31, the transmission unit 2 and the output disc 41 and reduce wear thereamong.

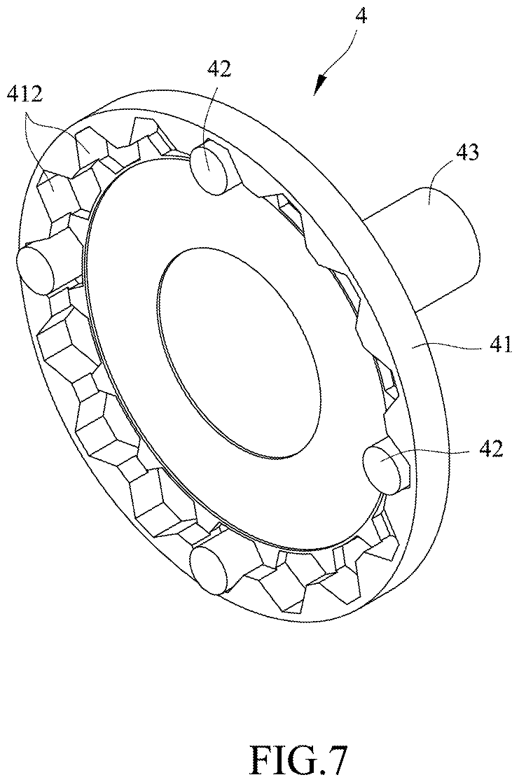

As shown in FIG. 7, in another modified embodiment, each of the input rollers 33 and each of the output rollers 42 are in the form of cylindrical rollers, and each of the second receiving grooves 412 of the output disc 41 has a trapezoidal cross-section such that a lube space is formed in each second receiving groove 412.

As illustrated, the conjugate cam reducer has a simple structure, and the input rollers 33 and the output rollers 42 are disposed in a freely rollable manner, which simplifies the manufacturing and assembling processes and meets the requirements for miniaturization.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A conjugate cam reducer comprising:
a transmission unit defining an axial hole which extends along an output axis, and including a smaller-diameter cam disc and a larger-diameter cam disc which extends from a side of said smaller-diameter cam disc along the output axis and which has an outer diameter larger than that of said smaller-diameter cam disc, said smaller-diameter cam disc having a plurality of first teeth which are formed circumferentially and angularly spaced apart from one another, and a plurality of first grooves each of which is formed between two adjacent ones of said first teeth, said larger-diameter cam disc having a plurality of second teeth which are formed circumferentially and angularly spaced apart from one another, and a plurality of second grooves each of which is formed between two adjacent ones of said second teeth;
an input unit connected with said transmission unit at a side thereof, and including
an input disc having first and second input disc sides opposite to each other along the output axis, said input disc defining a disc hole which extends from said first input disc side to said second input disc side, said input disc further having a smaller inner peripheral wall which extends from said second input disc side along the output axis and which engages with said smaller-diameter cam disc, and a plurality of first receiving grooves which extend radially and outwardly from said smaller inner peripheral wall and which are formed circumferentially and angularly spaced apart from one another, said first receiving grooves being respectively registered with and spatially communicate with said first grooves to cooperatively define a plurality of receiving spaces,
an eccentric shaft extending through said disc hole and said axial hole, and having an input shaft end which extends along an eccentric axis parallel to the output axis and which is rotated to drive rotation of said transmission unit in an eccentric cycloidal motion, and
a plurality of input rollers rollably disposed in said receiving spaces, respectively; and
an output unit connected with said transmission unit at an opposite side of said transmission unit opposite to said input unit, and including
an output disc having first and second output disc sides opposite to each other along the output axis and distal from and proximate to said input disc, respectively, a larger inner peripheral wall which extends from said second output disc side along the output axis toward said first output disc side and which engages with said larger-diameter cam disc, and a plurality of second receiving grooves which extend radially and outwardly from said larger inner peripheral wall and which are formed circumferentially and angularly spaced apart from one another, said second receiving grooves being respectively registered with and spatially communicate with said second grooves to cooperatively define a plurality of accommodation spaces, and
a plurality of output rollers rollably disposed in said accommodation spaces, respectively.

2. The conjugate cam reducer of claim 1, wherein each of said input rollers and each of said output rollers are in form of spherical balls.

3. The conjugate cam reducer of claim 1, wherein each of said input rollers and each of said output rollers are in form of cylindrical rollers each of which extends in a direction parallel to the output axis.

4. The conjugate cam reducer of claim 1, wherein each of said first receiving grooves of said input disc has a cross-section which is of one of trapezoidal, circular and Gothic arch shapes.

5. The conjugate cam reducer of claim 1, wherein each of said second receiving grooves of said output disc has a cross-section which is of one of trapezoidal, circular and Gothic arch shapes.

6. The conjugate cam reducer of claim 1, wherein said output unit further includes an output shaft which extends from said first output disc side of said output disc along the output axis and away from said transmission unit.
